(19) United States
(12) Patent Application Publication
(10) Pub. No.: US 2015/0022433 A1
(43) Pub. Date: Jan. 22, 2015

(54) DISPLAY CONTROL IN A DATA PROCESSING DEVICE BASED ON SENSING DEVIATION THEREOF FROM A REFERENCE POSITION

(71) Applicant: NVIDIA Corporation, Santa Clara, CA (US)

(72) Inventors: Rahul Marathe, Pune (IN); Shounak Deshpande, Pune (IN)

(21) Appl. No.: 13/944,914

(22) Filed: Jul. 18, 2013

(51) Int. Cl. G06F 3/01

(52) U.S. Cl. CPC G06F 3/01
USPC 345/156

(57) ABSTRACT

A method includes sensing, through a processor of a data processing device in conjunction with a motion sensor, a deviation of the data processing device from a reference position thereof. The method also includes modifying, through the processor, a display parameter of a display unit of the data processing device and/or display data to be rendered on the display unit in accordance with the sensed deviation.

### FIELD OF TECHNOLOGY

This disclosure relates generally to data processing devices and, more particularly, to display control in a data processing device based on sensing deviation thereof from a reference position.

### BACKGROUND

Display data rendered on a display unit of a data processing device (e.g., a tablet, a mobile device such as a mobile phone or a smart media player) may have particular values of display parameter(s) (e.g., screen brightness, color temperature, color contrast, resolution) associated therewith. In order to modify the display parameters, a user of the data processing device may have to manually utilize a physical button associated therewith and/or a virtual interface provided through a screen of the display unit. The aforementioned manual process may frustrate the user.

### SUMMARY

Disclosed are a method, a device and/or a system of display control in a data processing device based on sensing deviation thereof from a reference position.

In one aspect, a method includes sensing, through a processor of a data processing device in conjunction with a motion sensor, a deviation of the data processing device from a reference position thereof. The method also includes modifying, through the processor, a display parameter of a display unit of the data processing device and/or display data to be rendered on the display unit in accordance with the sensed deviation.

In another aspect, a data processing device includes a memory, a motion sensor, a display unit, and a processor communicatively coupled to the memory, the motion sensor and the display unit. The processor is configured to execute instructions to sense, in conjunction with the motion sensor, a deviation of the data processing device from a reference position thereof. The processor is also configured to execute instructions to modify a display parameter of the display unit and/or display data to be rendered on the display unit in accordance with the sensed deviation.

In yet another aspect, a non-transitory medium, readable through a data processing device and including instructions embodied therein that are executable through the data processing device, is disclosed. The non-transitory medium includes instructions to sense, through a processor of the data processing device in conjunction with a motion sensor, a deviation of the data processing device from a reference position thereof. The non-transitory medium also includes instructions to modify, through the processor, a display parameter of a display unit of the data processing device and/or display data to be rendered on the display unit in accordance with the sensed deviation.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments

FIG. 2 is a schematic view of interaction between a driver component and a processor, a display unit and/or a motion sensor of the data processing device of FIG. 1, according to one or more embodiments.

FIG. 3 is an illustrative view of a tablet as an example data processing device.

FIG. 4 is a schematic view of an example configuration capability provided through a user interface of an application and/or an operating system executing on the data processing device of FIG. 1.

FIG. 5 is an example illustrative view of shaking the data processing device of FIG. 1 to initiate sensing of a deviation thereof from a reference position and/or modification of display parameters and/or display data associated therewith.

FIG. 6 is a process flow diagram detailing the operations involved in display control in the data processing device of FIG. 1 based on sensing deviation thereof from a reference position, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of display control in a data processing device based on sensing deviation thereof from a reference position. Although the present embodiments have been described with reference to specific example embodiments, it will be evident that various modifications and changes may be made to these embodiments without departing from the broader spirit and scope of the various embodiments.

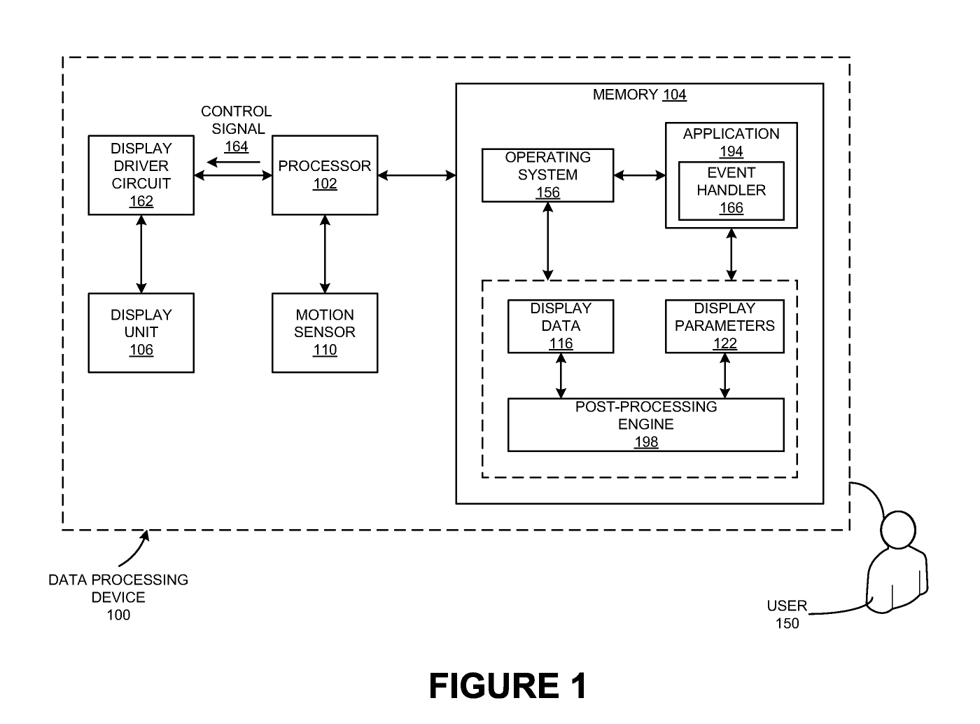

FIG. 1 shows a data processing device 100, according to one or more embodiments. In one or more embodiments, data processing device 100 may be a tablet or a mobile device such as a mobile phone and a smart media player. Other forms of data processing device 100 are also within the scope of the exemplary embodiments discussed herein. In one or more embodiments, data processing device 100 may include a processor 102 (e.g., a Central Processing Unit (CPU), a Graphics Processing Unit (GPU), a microcontroller, a microprocessor) communicatively coupled to a memory 104 (e.g., a volatile memory and/or a non-volatile memory); memory 104 may include storage locations configured to be addressable through processor 102. In one or more embodiments, processor 102 may execute instructions to provide several functionalities associated with data processing device 100.

In one or more embodiments, data processing device 100 may include a display unit 106 (e.g., Liquid Crystal Display (LCD)) interfaced with processor 102; display unit 106 may be configured to have display data 116 processed through processor 102 rendered thereon. FIG. 1 shows display data 116 as being stored in memory 104. In one or more embodiments, data processing device 100 may have a motion sensor 110 associated therewith configured to sense a movement of data processing device 100 with respect to a reference position (e.g., a reference angular position) thereof in conjunction with processor 102. FIG. 1 shows motion sensor 110 as being interfaced with processor 102. In one or more example embodiments, a translation and/or a rotation of data processing device 100 by a user 150 thereof may cause a deviation of data processing device 100 from the reference position. In one or more embodiments, the deviation may be sensed through motion sensor 110 in conjunction with processor 102, based on which a display parameter (e.g., color contrast, color temperature, resolution, screen brightness, color sharpness) associated with display unit 106 is modified through processor 102. In one or more embodiments, display data 116 may also be modified (e.g., enhanced) based on the sensing.

FIG. 1 shows display parameters 122 as being stored in memory 104. In one or more embodiments, display parameters 122 may be interpretable through an operating system 156 executing on data processing device 100. FIG. 1 also shows operating system 156 as being stored in memory 104 (e.g., non-volatile memory). In one example embodiment, display parameters 122 may be defined by an Original Design Manufacturer (ODM) of display unit 106 in a driver component (e.g., a set of instructions) thereof. In one example scenario, user 150 may be using a mobile phone (example data processing device 100) in an environment that matches a background color of a screen of display unit 106. Exemplary embodiments may provide for a means to modify the background color (example display parameter 122) to provide for contrast with the background color of the environment.

In another example scenario, display data 116 rendered on display unit 106 may have edge features therein diminished; an edge here refers to a portion of a video frame/image of display data 116 having an intensity level difference from a previous portion thereof above a threshold. User 150 may pre-configure data processing device 100 with a deviation that corresponds to a requirement of processing display data 116 to perform edge enhancement. Exemplary embodiments provide for a means to modify display data 116 in accordance with the sensed deviation.

It should be noted that modification of display data 116 may not be limited to the edge enhancement discussed above. Other forms of modification such as noise reduction, software processing amplifier (procamp) adjustment and deinterlacing are within the scope of the exemplary embodiments discussed herein. In other words, exemplary embodiments provide for personalization/customization of a display environment of user 150 based on sensing deviation of data processing device 100 from a reference position thereof.

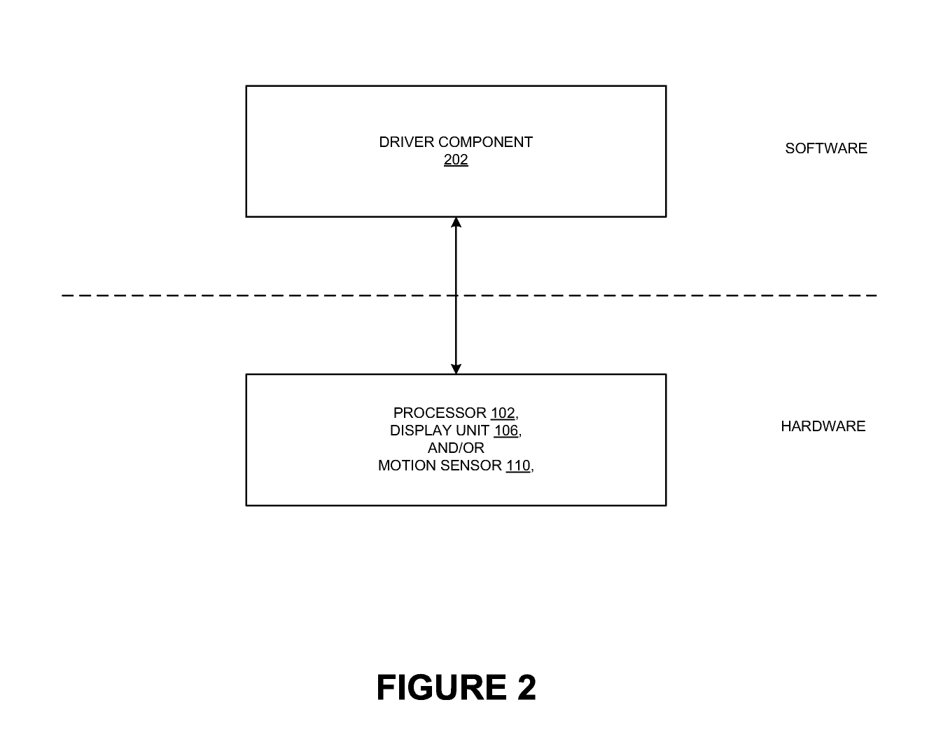

In one or more embodiments, a driver component (e.g., a set of instructions) associated with processor 102, display unit 106 and/or motion sensor 110 may be configured to trigger the abovementioned sensing and/or the modification of display parameter(s) 122 and/or display data 116. FIG. 2 shows interaction between a driver component 202 and processor 102, display unit 106 and/or motion sensor 110, according to one or more embodiments. In one or more embodiments, driver component 202 may be packaged with operating system 156 and/or an application (e.g., application 194) executing on data processing device 100. In one or more embodiments, driver component 202 may be loaded onto data processing device 100 upon booting thereof. In one or more embodiments, instructions associated with driver component 202 may be embodied in a non-transitory medium (e.g., Compact Disc (CD), Digital Video Disc (DVD), Blu-ray disc®, hard drive; appropriate instructions may be downloaded to the hard drive) readable through data processing device 100.

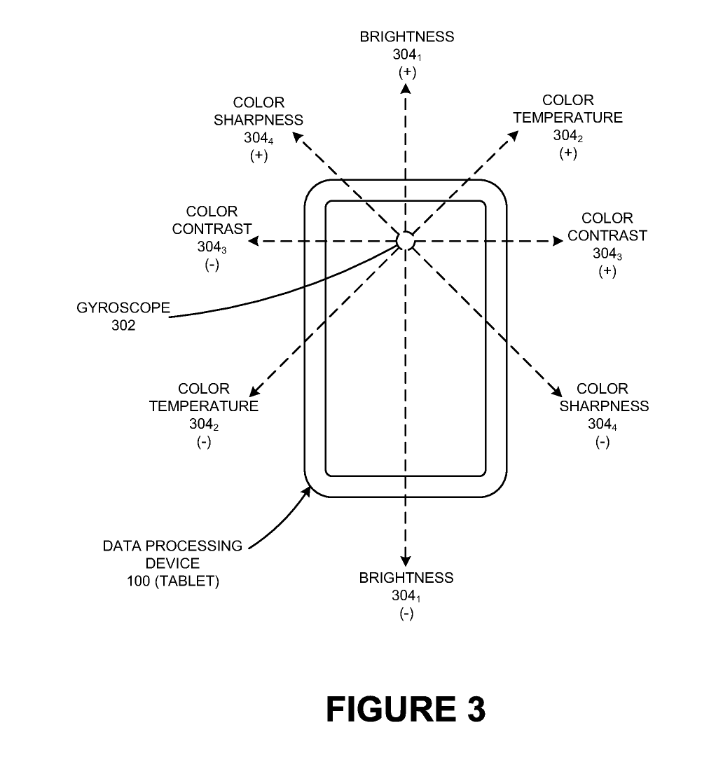

FIG. 3 shows a tablet as an example data processing device 100. Here, tablet may include a gyroscope 302 as an example motion sensor 110. Here, tilts/rotations toward specific directions may be associated with modifications of display parameter(s) 122. For example, a vertical tilt may be associated with adjustment of brightness 304₁; in other words, tilting data processing device 100 upward around a width thereof may correspond to an increase in brightness 304₁ and tilting data processing device 100 downward around the width thereof may correspond to a decrease in brightness 304₁. FIG. 3 shows tilting of data processing device 100 to effect appropriate modifications of color temperature 304₂, color contrast 304₃ and color sharpness 304₄. It is obvious that other display parameters 122 may be modified.

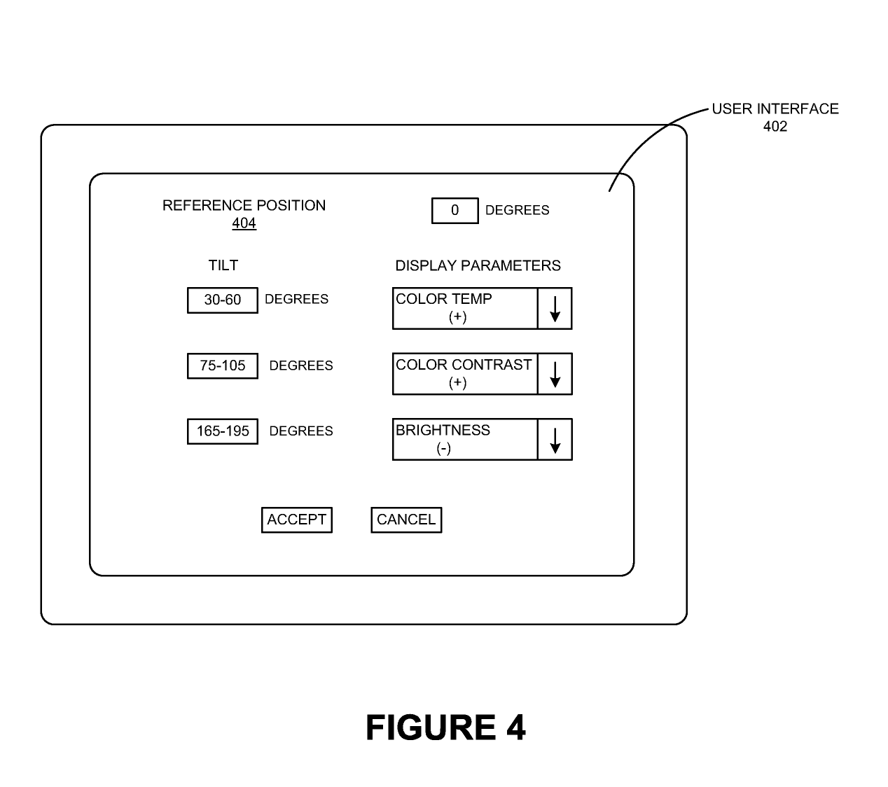

Correspondence between the abovementioned directions and modification of display parameters 122 may be established through appropriate definitions in driver component 202. Alternately, user 150 may define the aforementioned correspondence through a user interface of application 194 and/or operating system 156. FIG. 4 shows an example configuration capability provided through a user interface 402 (e.g., accessible through a screen of display unit 106) of application 194 and/or operating system 156. Upon accepting the definitions, data processing device 100 may be pre-configured to modify display parameters 122 appropriately in accordance with the sensed deviation of data processing device 100. It is to be noted that the acceptance of the definitions may enable the correspondence being defined through driver component 202.

In one or more embodiments, the abovementioned definition may involve definition of a reference position 404 relative to which motion of data processing device 100 is defined. Calibration of motion sensor 110 and/or the aforementioned definition of reference position 404 may be performed by user 150 initially. Alternately, the ODM associated with data processing device 100 may pre-define reference position 404 through driver component 202 and/or pre-calibrate data processing device 100. In one or more embodiments, reference position 404 may be one or more spatial coordinate(s), one or more angular coordinate(s) or a combination thereof. It is obvious that the correspondence between positions relative to reference position 404 and display parameters 122 may be user-configurable.

In one or more embodiments, the abovementioned sensing and/or the modification of display parameters 122 and/or display data 116 (to be discussed later) may require an initiation process. In one example embodiment, the initiation may be effected by user 150 moving data processing device 100 to a pre-defined direction relative to reference position 404. Here, motion sensor 110 (e.g., gyroscope 302) may also be utilized during the initiation process. Alternately, the initiation may be effected through user 150 shaking data processing device 100 to activate the sensing and/or the modification of display parameters 122 and/or display data 116. Here, an accelerometer (e.g., motion sensor 110, another sensor) may be utilized to sense an acceleration due to the aforementioned shaking of data processing device 100. It should also be noted that the accelerometer may also be used in sensing the movement of data processing device 100 relative to reference position 404 discussed above, based on which display parameters 122 and/or display data 116 is to be modified.

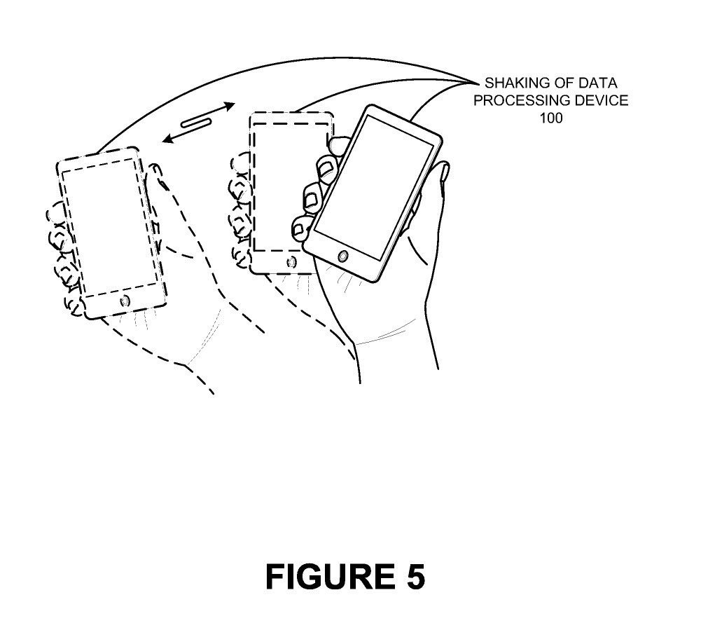

FIG. 5 shows shaking of data processing device 100 to initiate the sensing and/or the modification of display parameters 122 and/or display data 116. It should be noted that other forms of motion sensor 110 may be utilized in the aforementioned initiation and/or the sensing of the movement of data processing device 100 relative to reference position 404. Further, it should be noted that the initiation may not be limited to the shaking of data processing device 100 discussed above. Other forms of initiation (e.g., through a physical button on data processing device 100, through a virtual interface (e.g., a button) accessible through the screen of display unit 106, through a voice command interpretable through processor 102 of data processing device 100, through a coded gesture (e.g., a tapping pattern of a finger/fingers of user 150) interpretable through appropriate circuitry provided in data processing device 100 in conjunction with processor 102, through appropriate one or more hotkey(s), through a text input interpretable through processor 102, through user interface 402, automatic initiation following the abovementioned correspondence definition in driver component 202) are also within the scope of the exemplary embodiments discussed herein.

In yet another example embodiment, the correspondence definition through user interface 402 discussed above may also include the initiation through one or more of the abovementioned ways, which exposes user interface 402 to user 150 through the screen of display unit 106. User 150 may then control/modify the definitions through user interface 402 (e.g., through a slider control, a knob control).

FIG. 1 also shows a display driver circuit 162 configured to control display unit 106. In one or more embodiments, following the sensing of the motion of data processing device 100 relative to reference position 404, processor 102 may be configured to transmit a control signal 164 to control display driver circuit 162, based on which one or more display parameters 122 of display unit 106 may be modified. FIG. 1 also shows an event handler 166 (e.g., a subroutine) as being part of application 194; event handler 166 may be configured to handle the initiation processes (e.g., shaking of data processing device 100) discussed above at a level of operating system 156. Event handler 166, in turn, may then initiate loading of instructions associated with driver component 202, which leads to the sensing and/or the modification of display parameters 122 and/or display data 116. Other forms of implementation of event handler 166 are within the scope of the exemplary embodiments.

In one or more embodiments, the modification of display parameters 122 and/or display data 116 may be automatically performed. Alternately, user 150 may be provided an option through an interface (e.g., screen interface of display unit 106) of data processing device 100 to manually confirm (e.g., by tapping a virtual confirmation button onscreen) the modifications. Other reasonable variations are also within the scope of the exemplary embodiments.

With regard to the modification of display data 116, processor 102 may execute a post-processing engine 198 thereon; FIG. 1 shows post-processing engine 198 as being stored in memory 104. In one or more embodiments, post-processing engine 198 may include one or more algorithms associated with example processing such as noise reduction, edge enhancement, video format conversion and deinterlacing, which are configured to be applied on display data 116. In one example embodiment, user 150 may desire viewing of video data (example display data 116) in a specific format (say, MPEG-4). The appropriate format conversion may have a corresponding gesture (e.g., tilting direction/angle) of data processing device 100 associated therewith. Upon sensing the appropriate deviation of data processing device 100 with respect to reference position 404, processor 102 may be configured to execute post-processing engine 198 to convert display data 116 from a current format to MPEG-4. Then, display data 116 may be rendered on display unit 106 in the MPEG-4 format.

It should be noted that instructions associated with post-processing engine 198 may also be made available in a non-transitory medium (e.g., Compact Disc (CD), Digital Video Disc (DVD), Blu-ray disc®, hard drive; appropriate instructions may be downloaded to the hard drive) readable through data processing device 100. Further, it should be noted that modification of display data 116 may include processing display data 116 to render display data 116 at a reduced level to provide for power savings. For example, data processing device 100 may be operating at a reduced battery level. Here, the complexity of post-processing algorithm(s) (e.g., implemented in post-processing engine 198) applied on display data 116 may be reduced based on an appropriate gesture (e.g., an appropriate tilt) on part of user 150.

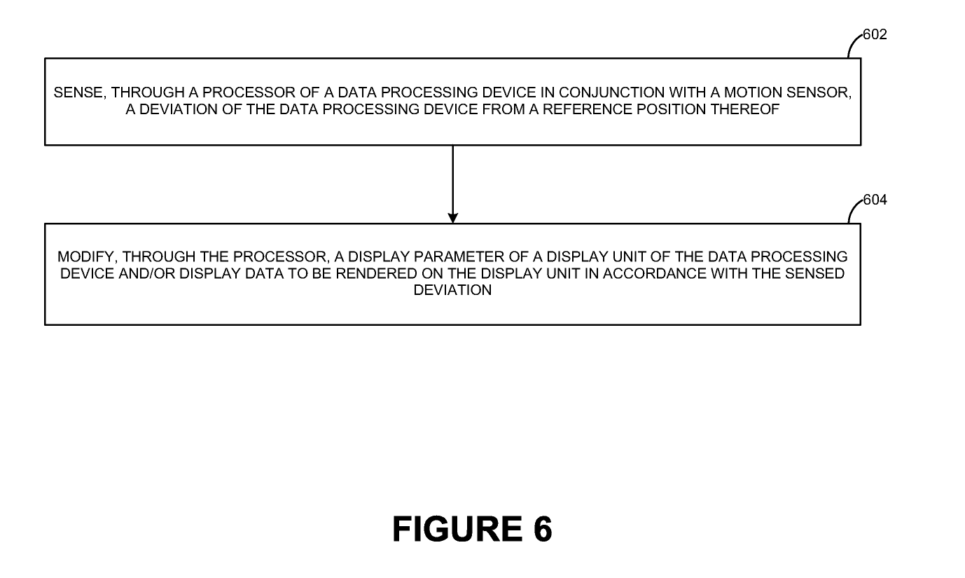

FIG. 6 shows a process flow diagram detailing the operations involved in display control in data processing device 100 based on sensing deviation thereof from a reference position (e.g., reference position 404), according to one or more embodiments. In one or more embodiments, operation 602 may involve sensing, through processor 102 in conjunction with motion sensor 110, a deviation of data processing device 100 from the reference position thereof. In one or more embodiments, operation 604 may then involve modifying, through processor 102, a display parameter (e.g., display parameter 122) of display unit 106 and/or display data 116 to be rendered on display unit 106 in accordance with the sensed deviation.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., data processing device 100). Accordingly, the specification and drawings are to be regarded in an illustrative rather than a restrictive sense.

What is claimed is:

1. A method comprising:
sensing, through a processor of a data processing device in conjunction with a motion sensor, a deviation of the data processing device from a reference position thereof; and
modifying, through the processor, at least one of a display parameter of a display unit of the data processing device and display data to be rendered on the display unit in accordance with the sensed deviation.

2. The method of claim 1, further comprising initiating the sensing of the deviation of the data processing device through at least one of:
a physical movement of the data processing device interpretable therethrough,
a voice command interpretable through the processor,
a physical button on the data processing device,
a virtual interface accessible through a screen of the display unit,
a text input interpretable through the processor,
a coded gesture interpretable through the processor,
at least one hotkey, and
a user interface of at least one of an application executing on the data processing device and an operating system executing on the data processing device.

3. The method of claim 1, comprising providing at least one of a gyroscope and an accelerometer as the motion sensor associated with the data processing device.

4. The method of claim 1, further comprising triggering, through a driver component associated with at least one of the processor, the display unit and the motion sensor, at least one of the sensing of the deviation of the data processing device and the modification of the at least one of the display parameter and the display data.

5. The method of claim 4, comprising providing the driver component at least one of: packaged with an application executing on the data processing device and packaged with an operating system executing on the data processing device.

6. The method of claim 1, wherein modifying the at least one of the display parameter and the display data through the processor further comprises at least one of:
transmitting a control signal to a display driver circuit of the display unit to enable the modification of the display parameter; and
processing the display data to enable rendering of the display data on the display unit at one of: a reduced level and an enhanced level.

7. The method of claim 1, further comprising at least one of:
utilizing a user interface of at least one of an application executing on the data processing device and an operating system executing on the data processing device to define a correspondence between a particular deviation from the reference position and a particular modification of the at least one of the display parameter and the display data;
at least one of calibrating the motion sensor and defining the reference position through the user interface;
pre-defining at least one of the correspondence between the particular deviation and the particular modification and the reference position in a driver component associated with at least one of the processor, the display unit and the motion sensor; and
confirming the modification through at least one of the user interface and a screen of the display unit to effect a corresponding change associated therewith.

8. A data processing device comprising:
a memory;
a motion sensor;
a display unit; and
a processor communicatively coupled to the memory, the motion sensor and the display unit, the processor being configured to execute instructions to:
sense, in conjunction with the motion sensor, a deviation of the data processing device from a reference position thereof, and
modify at least one of a display parameter of the display unit and display data to be rendered on the display unit in accordance with the sensed deviation.

9. The data processing device of claim 8, wherein the sensing of the deviation of the data processing device is initiated through at least one of:
a physical movement of the data processing device interpretable therethrough,
a voice command interpretable through the processor,
a physical button on the data processing device,
a virtual interface accessible through a screen of the display unit,
a text input interpretable through the processor,
a coded gesture interpretable through the processor,
at least one hotkey, and
a user interface of at least one of an application executing on the data processing device and an operating system executing on the data processing device.

10. The data processing device of claim 8, wherein the motion sensor comprises at least one of a gyroscope and an accelerometer.

11. The data processing device of claim 8, further comprising a driver component associated with at least one of the processor, the display unit and the motion sensor, to trigger at least one of the sensing of the deviation of the data processing device and the modification of the at least one of the display parameter and the display data.

12. The data processing device of claim 11, wherein the driver component is at least one of: packaged with an application executing on the data processing device and packaged with an operating system executing on the data processing device.

13. The data processing device of claim 8, wherein the processor is configured to execute instructions to modify the at least one of the display parameter and the display data based on at least one of:
transmitting a control signal to a display driver circuit of the display unit to enable the modification of the display parameter, and
processing the display data to enable rendering of the display data on the display unit at one of: a reduced level and an enhanced level.

14. The data processing device of claim 8, wherein at least one of:
a user interface of at least one of an application executing on the data processing device and an operating system executing on the data processing device is utilized to define a correspondence between a particular deviation from the reference position and a particular modification of the at least one of the display parameter and the display data,
the user interface is utilized to at least one of: calibrate the motion sensor and define the reference position,
the data processing device further comprises a driver component associated with at least one of the processor, the display unit and the motion sensor, the driver component having at least one of the correspondence between the particular deviation and the particular modification and the reference position pre-defined therein, and
wherein the modification is configured to be confirmed through at least one of the user interface and a screen of the display unit to effect a corresponding change associated therewith.

15. A non-transitory medium, readable through a data processing device and including instructions embodied therein that are executable through the data processing device, comprising:
instructions to sense, through a processor of the data processing device in conjunction with a motion sensor, a deviation of the data processing device from a reference position thereof; and
instructions to modify, through the processor, at least one of a display parameter of a display unit of the data processing device and display data to be rendered on the display unit in accordance with the sensed deviation.

16. The non-transitory medium of claim 15, further comprising instructions to initiate the sensing of the deviation of the data processing device through at least one of:
a physical movement of the data processing device interpretable therethrough,
a voice command interpretable through the processor,
a physical button on the data processing device,
a virtual interface accessible through a screen of the display unit,
a text input interpretable through the processor,
a coded gesture interpretable through the processor,
at least one hotkey, and
a user interface of at least one of an application executing on the data processing device and an operating system executing on the data processing device.

17. The non-transitory medium of claim 15, comprising instructions compatible with at least one of a gyroscope and an accelerometer being the motion sensor associated with the data processing device.

18. The non-transitory medium of claim 15, further comprising instructions to trigger, through a driver component associated with at least one of the processor, the display unit and the motion sensor, at least one of the sensing of the deviation of the data processing device and the modification of the at least one of the display parameter and the display data.

19. The non-transitory medium of claim 15, wherein the instructions to modify the at least one of the display parameter and the display data through the processor further comprises at least one of:
instructions to transmit a control signal to a display driver circuit of the display unit to enable the modification of the display parameter; and
instructions to process the display data to enable rendering of the display data on the display unit at one of: a reduced level and an enhanced level.

20. The non-transitory medium of claim 15, further comprising instructions compatible with at least one of:
utilizing a user interface of at least one of an application executing on the data processing device and an operating system executing on the data processing device to define a correspondence between a particular deviation from the reference position and a particular modification of the at least one of the display parameter and the display data,
at least one of calibrating the motion sensor and defining the reference position through the user interface,
pre-defining at least one of: the correspondence between the particular deviation and the particular modification and the reference position in a driver component associated with at least one of the processor, the display unit and the motion sensor, and
confirming the modification through at least one of the user interface and a screen of the display unit to effect a corresponding change associated therewith.
